(19) United States
(12) Patent Application Publication
(10) Pub. No.: US 2026/0188271 A1
(43) Pub. Date: Jul. 2, 2026

(54) DISPLAY APPARATUS

(71) Applicant: LG Display Co., Ltd., Seoul (KR)

(72) Inventors: Gyu Sik WON, Paju-si (KR); Cheol Woo PARK, Paju-si (KR); Dae Hyun NAM, Paju-si (KR); Chan Soo PARK, Paju-si (KR)

(73) Assignee: LG Display Co., Ltd., Seoul (KR)

(21) Appl. No.: 19/421,582

(22) Filed: Dec. 16, 2025

(30) Foreign Application Priority Data
Dec. 27, 2024 (KR) 10-2024-0198939

(51) Int. Cl. G09G 3/36; G09G 3/34

(52) U.S. Cl. CPC G09G 3/3607; G09G 3/3406; G09G 2300/0426; G09G 2320/0233; G09G 2360/144

(57) ABSTRACT

A display apparatus includes a liquid crystal panel having an active area, a sensing area, and a peripheral area, a backlight unit having a backlight source configured to supply light to the active area through a backlight guide plate provided in the backlight unit, an auxiliary light source configured to supply light to the sensing area and the peripheral area, and an optical module located on a rear surface of the liquid crystal panel and configured to detect external light through the sensing area. A data voltage is supplied to at least one subpixel located in each of the active area, the sensing area, and the peripheral area, and the data voltage supplied to the sensing area or the peripheral area is different from the data voltage supplied to the active area depending on the brightness of the auxiliary light source.

### CROSS-REFERENCE TO RELATED APPLICATIONS

This application claims the benefit of Korean Patent Application No. 10-2024-0198939, filed on Dec. 27, 2024, the entire contents of which are incorporated herein by reference for all purposes.

### BACKGROUND

### 1. Technical Field

The present disclosure relates to a display apparatus.

### 2. Description of Related Art

In general, a display apparatus provides an image to a user. For example, the display apparatus may include a liquid crystal panel located on a backlight unit. The liquid crystal panel may generate an image using light supplied from the backlight unit. For example, the liquid crystal panel may include subpixels.

The display apparatus may include an optical module to detect external light. For example, the optical module may include at least one of a camera or an IR sensor. The optical module may overlap some area of the liquid crystal panel. For example, the liquid crystal panel may include a sensing area that overlaps the optical module. The sensing area may have a relatively high transmittance.

In addition, an auxiliary light source to supply light to the sensing area of the liquid crystal panel may be provided, and a peripheral area of the liquid crystal panel where the auxiliary light source is provided may be larger than the sensing area.

However, a difference in luminosity efficiency may occur between images displayed due to a difference in transmittance between an active area and the sensing area in the liquid crystal panel, and since a different light source is used in the peripheral area and the sensing area from the active area, a sense of incongruity and a difference in luminosity efficiency between images displayed in the active area, and the peripheral area or the sensing area may occur.

The description of related art should not be considered prior art merely because it is mentioned in or associated with this section. The description of related art includes information that describes one or more aspects of the subject technology, and the description in this section does not limit the scope of the present disclosure.

### SUMMARY

Accordingly, the present disclosure is directed to a display apparatus that substantially obviates one or more problems due to limitations and disadvantages of the related art.

An aspect of the present disclosure is to provide a display apparatus that may improve sense of incongruity and a difference in luminosity efficiency between images displayed in an active area, and a peripheral area or a sensing area may occur.

The aspects of the present disclosure are not limited to the above-mentioned aspects. The aspects of the present disclosure that are not mentioned herein will be clearly understood by those skilled in the art from the following description.

Additional advantages, aspects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these aspects and other advantages and in accordance with the purpose of the disclosure, as embodied and broadly described herein, a display apparatus includes a liquid crystal panel including an active area, a sensing area surrounded by the active area, and a peripheral area located between the active area and the sensing area, a backlight unit having a backlight source configured to supply light to the active area through a backlight guide plate, an auxiliary light source configured to supply light to the sensing area and the peripheral area, and an optical module located on a rear surface of the backlight unit and configured to detect external light through the sensing area, wherein the display apparatus is configured to supply a data voltage to at least one subpixel located in each of the active area, the sensing area, and the peripheral area, and the data voltage supplied to the sensing area or the peripheral area is different from the data voltage supplied to the active area.

A number of white subpixels configured to display white per unit area positioned in the sensing area may be greater than a number of white subpixels per unit area positioned in each of the active area and the peripheral area.

Subpixels configured to display red, green, or blue and white subpixels may be located in the sensing area, and subpixels configured to display red, green, or blue may be located in the active area and the peripheral area and white subpixels may not be located in the active area and the peripheral area.

A brightness of the auxiliary light source may be the same as a brightness of the backlight source, a first voltage may be supplied as the data voltage to the at least one subpixel located in each of the active area and the peripheral area, and a second voltage different from the first voltage may be supplied as the data voltage to the at least one subpixel located in the sensing area. Here, the second voltage may be lower than the first voltage.

A difference between the first voltage and the second voltage may increase as the brightness of the backlight source and the auxiliary light source increases.

A brightness of the auxiliary light source may be higher than a brightness of the backlight source, a first voltage may be supplied as the data voltage to at least one subpixel turned on among a plurality of subpixels located in the sensing area and the at least one subpixel located in the active area, and a third voltage different from the first voltage may be supplied as the data voltage to the at least one subpixel located in the peripheral area. Here, the third voltage may be lower than the first voltage.

Among the plurality of subpixels located in the sensing area, subpixels configured to display red, green, or blue may be turned on, and white subpixels may be turned off.

A difference between the first voltage and the third voltage may increase as a brightness of an image displayed on the liquid crystal panel increases.

The white subpixels may not be provided with a color filter having red, green, or blue.

The display apparatus may further include an auxiliary light guide plate configured to overlap the sensing area and the peripheral area, and the auxiliary light source may supply the light to the sensing area and the peripheral area through the auxiliary light guide plate.

The display apparatus may further include at least one optical sheet between the liquid crystal panel and the backlight guide plate, and the at least one optical sheet may have an optical sheet hole in a portion thereof configured to overlap the sensing area.

The optical module may include at least one of a camera or an IR sensor in a portion thereof configured to overlap the sensing area.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic view illustrating a display apparatus according to one embodiment of the present disclosure;

FIG. 2 is a cross-sectional view taken along line A1-A1′ of FIG. 1;

FIG. 3 is a circuit diagram of a subpixel located in a liquid crystal panel in the display apparatus according to one embodiment of the present disclosure;

FIG. 4 is an enlarged view of area K1 of FIG. 2;

FIG. 5 is an enlarged view of area K2 of FIG. 1;

FIG. 6 is a view illustrating an example of a cross-section taken along line A2-A2′ and A3-A3′ of FIG. 5;

FIG. 7 is a view illustrating an example of a cross-section taken along line A4-A4′ of FIG. 5;

FIGS. 8(a) to 11 are diagrams illustrating a method of improving a difference in luminosity efficiency in a sensing area and a peripheral area compared to an active area, when the sensing area and the peripheral area are driven in a mono mode according to a first embodiment of the present disclosure; and

FIGS. 12(a) to 15 are diagrams illustrating a method of improving a difference in luminosity efficiency in the sensing area and the peripheral area compared to the active area, when the sensing area and the peripheral area are driven in a resolution change mode according to a second embodiment of the present disclosure.

### DETAILED DESCRIPTION

The aspects and technical configurations of the present disclosure and the resulting operational effects will be more clearly understood by the following detailed description with reference to the drawings illustrating embodiments of the present disclosure. Here, since the embodiments of the present disclosure are provided to fully convey the technical idea of the present disclosure to those skilled in the art, the present disclosure may be embodied in other forms so as not to be limited to the embodiments described below.

In addition, parts indicated by the same reference numerals throughout the description mean the same components, and the lengths and thicknesses of layers or regions in the drawings may be exaggerated for convenience. In addition, when a first component is referred to as being “on” a second component, the first component may be directly on the second component, or a third component may be located between the first component and the second component.

It is understood that, although the terms “first,” “second,” “A,” “B,” “(a),” “(b),” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. Further, these are not used to define the essence or basis of the elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

The terms used in the description of the present disclosure are used only to describe specific embodiments and are not intended to limit the present disclosure. For example, a component expressed in the singular includes plural components unless the context clearly indicates otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

In addition, the terms “comprises,” “comprising,” “including,” and “having,” are inclusive and therefore specify the presence of stated features, integers, steps, operations, elements, and/or components, but do not preclude the possibility of the presence or addition of one or more other features, integers, steps, operations, elements, components, and/or groups thereof.

In addition, unless otherwise defined, all terms used herein, including technical or scientific terms, have the same meanings as generally understood by those skilled in the art to which the present disclosure pertains. Terms defined in commonly used dictionaries should be interpreted as having meanings consistent with their meanings in the context of the relevant art, and will not be interpreted as having ideal or excessively formal meanings unless the context defines the meanings explicitly.

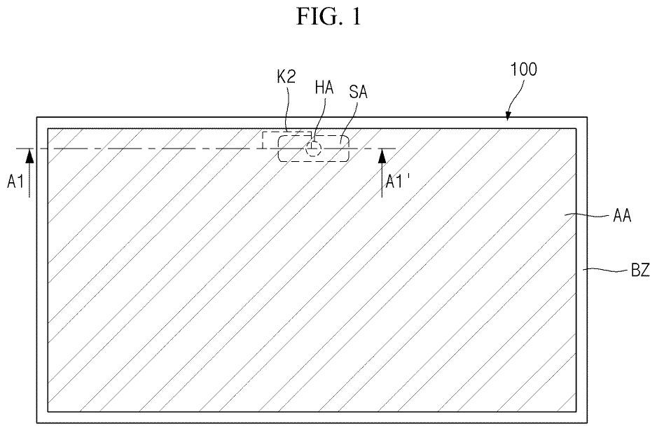

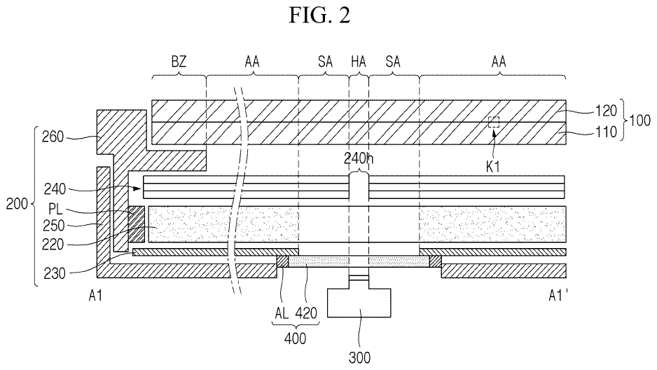

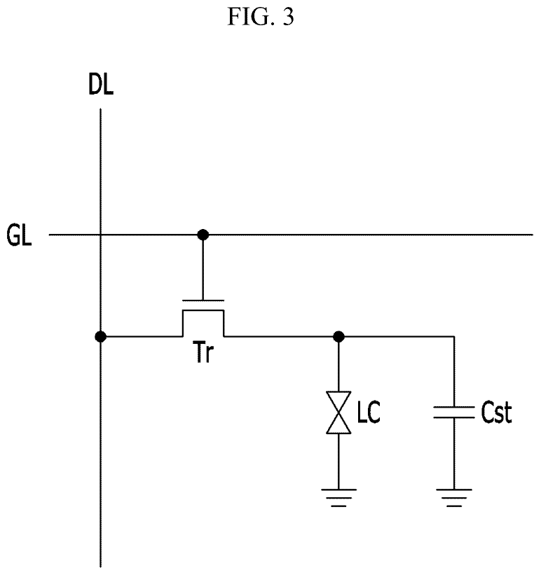

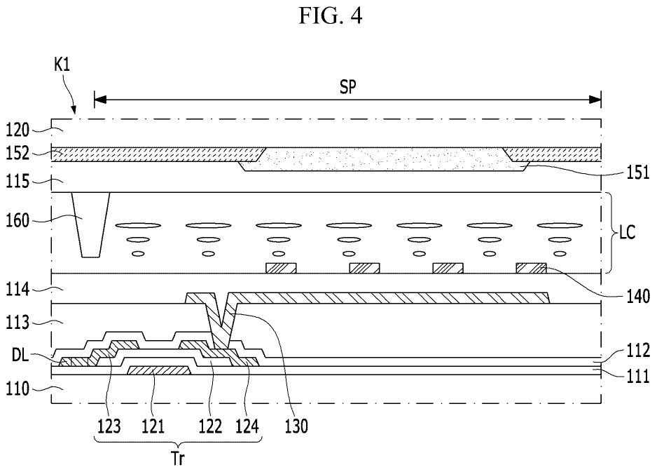

FIG. 1 is a schematic view showing a display apparatus according to one embodiment of the present disclosure, FIG. 2 is a cross-sectional view taken along line A1-A1′ of FIG. 1, FIG. 3 is a circuit diagram of a subpixel located in a liquid crystal panel in the display apparatus according to one embodiment of the present disclosure, and FIG. 4 is an enlarged view of area K1 of FIG. 2.

Referring to FIGS. 1 to 4, the display apparatus according to one embodiment of the present disclosure may include a liquid crystal panel 100. The liquid crystal panel 100 may generate an image to be provided to a user. For example, the liquid crystal panel 100 may include a plurality of subpixels SP (in FIG. 4).

Various signals may be applied to each subpixel SP through signal lines GL and DL (in FIG. 3). For example, the signal lines GL and DL may include gate lines GL that sequentially apply gate signals and data lines DL that apply data signals. The gate lines GL may intersect the data lines DL. For example, the gate lines GL may extend in a first direction (the x-axis direction), and the data lines DL may extend in a second direction (the y-axis direction) that is perpendicular to the first direction (the x-axis direction). The data lines DL may be located on a different layer from the gate lines GL.

The liquid crystal panel 100 may include an active area AA where subpixels SP on which an image is displayed are located, and a bezel area BZ located outside the active area AA. The subpixels SP may not be located or dummy subpixels on which an image is not displayed may be located in the bezel area BZ. For example, the active area AA may be surrounded by the bezel area BZ. A gate driver conductively connected to the gate lines GL and a data driver conductively connected to the data lines DL may be located outside the active area AA. For example, each signal line GL or DL may include a region overlapping the bezel area BZ of the liquid crystal panel 100.

A peripheral area SA and a sensing area HA may be located within the active area AA.

The sensing area HA may be an area overlapping an optical sheet hole 240h, and may overlap an optical module 300 located on the rear surface of the backlight unit 200. The optical module 300 may detect external light through the sensing area HA.

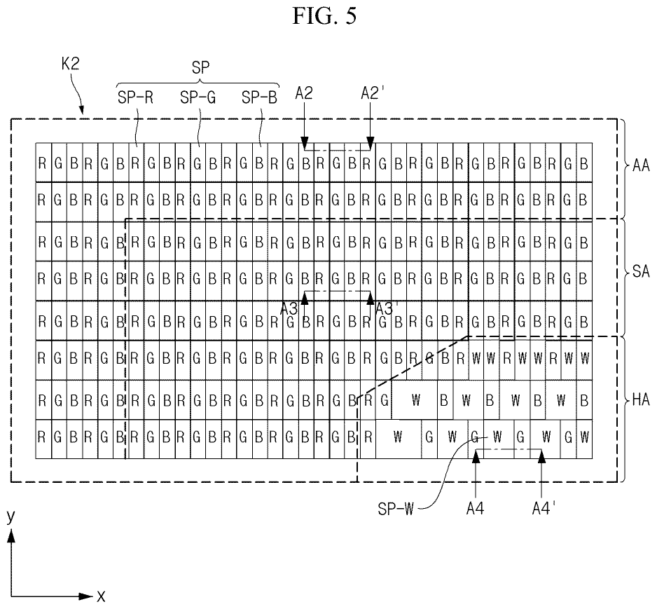

The transmittance of the sensing area HA by the liquid crystal panel 100 may be higher than the transmittance of the active area AA by the liquid crystal panel 100 in order to maximize detection of external light by the optical module 300. For example, red, green, blue subpixels may be located in the active area AA and, in addition to red, green, blue subpixels, white subpixels without a color filter may be located in the sensing area HA. This will be described in detail later with reference to FIG. 5.

In one or more examples, red subpixels may be subpixels configured to display red, green subpixels may be subpixels configured to display green, blue subpixels may be subpixels configured to display blue, and white subpixels may be subpixels configured to display white.

The peripheral area SA is located between the active area AA and the sensing area HA, and may be, for example, an area to which light from an auxiliary light source AL located on the rear surface of a backlight unit 200 is supplied, as shown in FIG. 2. The auxiliary light source AL may supply light to the peripheral area SA and the sensing area HA.

A subpixel structure and color arrangement in the peripheral area SA may be the same as a subpixel structure and color arrangement in the active area AA. Accordingly, the transmittance and aperture ratio of the peripheral area SA according to the structure of the liquid crystal panel 100 may be the same as the transmittance and aperture ratio of the active area AA. For example, the width, length, and color arrangement of the red, green, blue subpixels located in the peripheral area SA may be the same as the width, length, and color arrangement of the red, green, blue subpixels located in the active area AA.

The peripheral area SA and the sensing area HA may be driven by a separate light source different from the active area AA. For example, as shown in FIG. 2, in the liquid crystal panel 100, the active area AA may be supplied with light by a backlight source PL and a backlight guide plate 220, and the peripheral area SA and the sensing area HA may be supplied with light by the auxiliary light source AL and an auxiliary light guide plate 420.

The present disclosure may reduce a difference in luminosity efficiency occurring in the peripheral area SA and the sensing area HA compared to the active area AA in the liquid crystal panel 100 by making data voltages supplied to the respective areas AA, SA, and HA different from each other, in consideration of the transmittance of the liquid crystal panel 100 and the brightness of each of the backlight sources PL and the auxiliary light source AL. This will be described in detail after first explaining the structure of the liquid crystal panel 100.

The liquid crystal panel 100 may include a liquid crystal layer LC located between a first display substrate 110 and a second display substrate 120, as shown in FIGS. 2 and 3. The first display substrate 110 and the second display substrate 120 may include an insulating material. The first display substrate 110 and the second display substrate 120 may include a transparent material. For example, the first display substrate 110 and the second display substrate 120 may include glass or plastic.

The liquid crystal layer LC may include liquid crystals of various modes. For example, the liquid crystal layer LC may be driven as being normally black so as not to transmit light when no data voltage is applied, or as being normally white so as to transmit light when no data voltage is applied. Hereinafter, a case in which the liquid crystal layer LC is driven as being normally black will be described as a basic example.

The liquid crystals of the liquid crystal layer LC overlapping each subpixel SP may be rotated by a vertical electric field or a horizontal electric field formed within the corresponding subpixel SP by a gate signal and the data voltage of a data signal. For example, a pixel electrode 130 to form the horizontal electric field and a common electrode 140 overlapping some regions of the pixel electrode 130 may be located within each subpixel SP.

The liquid crystal layer LC may control the transmittance of light supplied from a light source depending on the magnitude of the data voltage applied. For example, when the liquid crystal layer LC is driven as being normally black, the transmittance of the liquid crystal layer LC increases as the magnitude of the data voltage increases, and the transmittance of the liquid crystal layer LC may decrease as the magnitude of the data voltage decreases. On the contrary, when the liquid crystal layer LC is driven as being normally white, the transmittance of the liquid crystal layer LC may increase as the magnitude of the data voltage decreases, and the transmittance of the liquid crystal layer LC may decrease as the magnitude of the data voltage increases. The transmittance of the liquid crystal panel 100 may be determined by the transmittance of the liquid crystal layer LC.

A constant power voltage may be supplied to the common electrode 140 of each subpixel SP. A driving voltage corresponding to a data signal applied to the data line DL (in FIG. 3) of the corresponding subpixel SP may be supplied to the pixel electrode 130 of each subpixel SP depending on a gate signal applied to the gate line GL (in FIG. 3) of the corresponding subpixel SP.

That is, in the display apparatus according to one embodiment of the present disclosure, a horizontal electric field may be formed in each subpixel SP by the driving voltage applied to the pixel electrode 130 of the corresponding subpixel SP and the power voltage applied to the common electrode 140. The driving voltage applied to the pixel electrode 130 of each subpixel SP may be maintained for one frame time. For example, at least one thin film transistor Tr and at least one storage capacitor Cst may be located in each subpixel SP.

The thin film transistor Tr of each subpixel SP may generate the driving voltage corresponding to the data signal applied to the corresponding subpixel SP depending on the gate signal applied to the corresponding subpixel SP. The thin film transistor Tr of each subpixel SP may be conductively connected to one of the gate lines GL and one of the data lines DL. For example, the thin film transistor Tr of each subpixel SP may include a gate electrode 121 conductively connected to one of the gate lines GL, a semiconductor pattern 122 including an area overlapping the gate electrode 121, a drain electrode 123 conductively connected to one end of the semiconductor pattern 122, and a source electrode 124 conductively connected to the other end of the semiconductor pattern 122.

The gate electrode 121 may include a conductive material. For example, the gate electrode 121 may include a metal, such as aluminum (Al), chromium (Cr), copper (Cu), molybdenum (Mo), titanium (Ti), or tungsten (W). The semiconductor pattern 122 may be located above the gate electrode 121. The semiconductor pattern 122 may include a semiconductor material. For example, the semiconductor pattern 122 may include an oxide semiconductor, such as amorphous silicon (a-Si), polycrystalline silicon (poly-Si), or IGZO. The semiconductor pattern 122 may include a channel region located between a drain region and a source region.

The drain region and the source region of the semiconductor pattern 122 may have a lower resistance than the channel region of the semiconductor pattern 122.

The semiconductor pattern 122 may be spaced apart from the gate electrode 121. The semiconductor pattern 122 may be insulated from the gate electrode 121. For example, the channel region of the semiconductor pattern 122 may have an electrical conductivity corresponding to a voltage supplied to the gate electrode 121. The drain region of the semiconductor pattern 122 may be conductively connected to the source region of the semiconductor pattern 122 depending on the signal applied to the gate electrode 121.

The drain electrode 123 and the source electrode 124 may include a conductive material. For example, the drain electrode 123 and the source electrode 124 may include a metal, such as aluminum (Al), chromium (Cr), copper (Cu), molybdenum (Mo), titanium (Ti), or tungsten (W).

The drain electrode 123 may be conductively connected to the drain region of the semiconductor pattern 122. The source electrode 124 may be conductively connected to the source region of the semiconductor pattern 122. The drain electrode 123 and the source electrode 124 may be insulated from the gate electrode 121.

The drain electrode 123 of each subpixel SP may be conductively connected to one of the data lines DL (in FIG. 3). The pixel electrode 130 of each subpixel SP may be conductively connected to the source electrode 124 of the corresponding subpixel SP.

In FIG. 3, the storage capacitor Cst of each subpixel SP may maintain the signal applied to the gate electrode 121 (in FIG. 4) of the corresponding subpixel SP for one frame time.

The thin film transistor Tr and the storage capacitor Cst of each subpixel SP may be located between the first display substrate 110 and the liquid crystal layer LC. A plurality of insulating films 111, 112, 113, and 114 configured to prevent unnecessary electrical connections may be located between the first display substrate 110 and the liquid crystal layer LC. For example, a gate insulating film 111, an element protection film 112, a planarization film 113, and an interlayer insulating film 114 may be located between the first display substrate 110 and the liquid crystal layer LC.

The gate insulating film 111 may be located close to the first display substrate 110. The semiconductor pattern 122 of each subpixel SP may be insulated from the gate electrode 121 of the corresponding subpixel SP by the gate insulating film 111. For example, the gate insulating film 111 may cover the gate electrode 121 of each subpixel SP. The semiconductor pattern 122 of each subpixel SP may be located on the gate insulating film 111. Each of the drain electrode 123 and the source electrode 124 of each subpixel SP may directly contact a region of the semiconductor pattern 122 located within the corresponding subpixel SP. For example, the drain electrode 123 and the source electrode 124 of each subpixel SP may be located on the gate insulating film 111. The gate insulating film 111 may include an insulating material. For example, the gate insulating film 111 may include an inorganic insulating material, such as silicon oxide (SiOₓ) or silicon nitride (SiNₓ).

The element protection film 112 may be located on the gate insulating film 111. The element protection film 112 may prevent damage to the thin film transistor Tr located within each subpixel SP due to external impact and moisture. For example, the semiconductor pattern 122, the drain electrode 123, and the source electrode 124 of each subpixel SP may be covered by the element protection film 112. The element protection film 112 may include an insulating material. For example, the element protection film 112 may include an inorganic insulating material, such as silicon oxide (SiOₓ) or silicon nitride (SiNₓ).

The planarization film 113 may be located on the element protection film 112. The planarization film 113 may remove steps caused by the thin film transistor Tr and the storage capacitor Cst of each subpixel SP. For example, the upper surface of the planarization film 113 facing the liquid crystal layer LC may be parallel to the upper surface of the first display substrate 110 facing the liquid crystal layer LC. The planarization film 113 may include an insulating material. The planarization film 113 may include a different material from the element protection film 112. The planarization film 113 may include a material having relatively high fluidity. For example, the planarization film 113 may include an organic insulating material.

The interlayer insulating film 114 may be located between the planarization film 113 and the liquid crystal layer LC. The common electrode 140 of each subpixel SP may be insulated from the pixel electrode 130 of the corresponding subpixel SP by the interlayer insulating film 114. For example, the interlayer insulating film 114 may cover the pixel electrode 130 of each subpixel SP. The common electrode 140 of each subpixel SP may be located between the interlayer insulating film 114 and the liquid crystal layer LC. The interlayer insulating film 114 may include an insulating material. For example, the interlayer insulating film 114 may include an inorganic insulating material.

Color filters 151, a black matrix 152, and an upper protective film 115 may be located between the liquid crystal layer LC and the second display substrate 120. The color filters 151 may overlap the subpixels SP. For example, each color filter 151 may overlap one of the subpixels SP. Each color filter 151 may represent a specific color using light having passed through the liquid crystal layer LC. For example, light having passed through each color filter 151 may represent one of red, blue, and green. The black matrix 152 may be located parallel to the color filters 151. For example, an end of each color filter 151 may overlap the black matrix 152. The black matrix 152 may include a material that may reflect or absorb light. For example, light having passed through the liquid crystal layer LC of each subpixel SP may pass through the color filter 151 of the corresponding subpixel SP located within an area defined by the black matrix 152 and be emitted to the outside. Accordingly, in the display apparatus according to one embodiment of the present disclosure, an image including various colors may be provided to the user.

The black matrix 152 may overlap the signal lines GL and DL. The thin film transistor Tr and the storage capacitor Cst of each subpixel SP may overlap the black matrix 152. Therefore, in the display apparatus according to one embodiment of the present disclosure, the signal lines GL and DL and the thin film transistor Tr and the storage capacitor Cst of each subpixel SP may not be recognized by a user due to the black matrix 152. That is, in the display apparatus according to one embodiment of the present disclosure, deterioration in quality of the image recognized by the user due to the signal lines GL and DL (in FIG. 3) and the thin film transistor Tr and the storage capacitor Cst of each subpixel SP may be prevented. The color filters 151 and the black matrix 152 may be covered by the upper protective film 115. The upper protective film 115 may prevent damage to the color filters 151 and the black matrix 152 due to external impact and moisture. The upper protective film 115 may include an insulating material. For example, the upper protective film 115 may include an inorganic insulating material, such as silicon oxide (SiOₓ) or silicon nitride (SiNₓ).

Spacers 160 may be located between the interlayer insulating film 114 and the upper protective film 115. The spacers 160 may maintain a constant gap between the interlayer insulating film 114 and the upper protective film 115. Accordingly, in the display apparatus according to one embodiment of the present disclosure, the liquid crystal layer LC of each subpixel SP may have the same thickness. Therefore, in the display apparatus according to one embodiment of the present disclosure, light passing through the liquid crystal layer LC of each subpixel SP may have the same optical path. In addition, in the display apparatus according to one embodiment of the present disclosure, light having passed through the liquid crystal layer LC of each subpixel SP may have the same brightness as light having passed through the liquid crystal layer LC of subpixels SP in which the same horizontal electric field as the corresponding subpixel SP is formed.

The liquid crystal panel 100 may be located on the backlight unit 200. The backlight unit 200 may supply light to the liquid crystal panel 100. For example, the liquid crystal panel 100 may generate an image to be provided to the user using the light supplied from the backlight unit 200. The backlight unit 200 may include the backlight source PL, the backlight guide plate 220, a reflector 230, an optical sheet 240, a bottom cover 250, and a middle frame 260.

The backlight source PL may supply light to the active area AA of the liquid crystal panel 100 through the backlight guide plate 220. For example, the backlight source PL may be located on one side surface of the backlight guide plate 220. The backlight source PL may include self-luminous elements capable of generating and emitting light. For example, the backlight source PL may include LEDs. The liquid crystal panel 100 may be located on the upper surface of the backlight guide plate 220.

The reflector 230 may be located on the lower surface of the backlight guide plate 220. The lower surface of the backlight guide plate 220 may face the upper surface of the backlight guide plate 220. For example, the backlight guide plate 220 may be located between the reflector 230 and the liquid crystal panel 100. The backlight guide plate 220 may have a refraction pattern that refracts light incident from the backlight source PL toward the liquid crystal panel 100. Such a refraction pattern may not be positioned in an area of the backlight guide plate 220 that overlaps the auxiliary light guide plate 420. That is, the refraction pattern of the backlight guide plate 220 may not be positioned in the sensing area HA and the peripheral area SA.

The reflector 230 may include a material that may reflect light. For example, the reflector 230 may include a metal, such as aluminum (Al) or silver (Ag). Accordingly, in the display apparatus according to one embodiment of the present disclosure, light emitted through the lower surface of the backlight guide plate 220 may be reflected toward the liquid crystal panel 100 by the reflector 230. A portion of the reflector 230 that overlaps the sensing area HA and the peripheral area SA may be opened, and light from the auxiliary light source AL may be incident on the sensing area HA and the peripheral area SA through the opened portion of the reflector 230.

The optical sheet 240 may be located between the backlight guide plate 220 and the liquid crystal panel 100. The light supplied to the liquid crystal panel 100 through the backlight guide plate 220 may have an overall uniform brightness by the optical sheet 240. For example, the optical sheet 240 may have a stacked structure including a prism sheet and a diffusion sheet. Therefore, in the display apparatus according to one embodiment of the present disclosure, light may be supplied uniformly to the entire area of the liquid crystal panel 100. The optical sheet 240 may have the optical sheet sheet hole 240h in a portion thereof overlapping the sensing area HA, in order to improve transmittance in the sensing area HA and maximize external light detection by the optical module 300.

The backlight source PL, the backlight guide plate 220, the reflector 230, and the optical sheet 240 may be accommodated in the bottom cover 250. The bottom cover 250 may include an insulating material. For example, the bottom cover 250 may include plastic. The bottom cover 250 may include a bottom surface and a side wall protruding from an edge of the bottom surface. The reflector 230 may be located between the backlight guide plate 220 and the bottom surface of the bottom cover 250. The backlight source PL, the backlight guide plate 220, and the optical sheet 240 may be located in a space formed by the side wall of the bottom cover 250. For example, the side wall of the bottom cover 250 may surround the backlight source PL, the backlight guide plate 220, and the optical sheet 240.

The middle frame 260 may support the liquid crystal panel 100. The middle frame 260 may be coupled to the bottom cover 250. For example, the middle frame 260 may include a coupling area extending between the bottom cover 250 and the backlight guide plate 220. The backlight source PL may be fixed to the coupling area of the middle frame 260. For example, the backlight source PL may be attached to the coupling area of the middle frame 260 by an adhesive member. The middle frame 260 may include a mounting area extending between the optical sheet 240 and the liquid crystal panel 100. The mounting area of the middle frame 260 may overlap the edge of the optical sheet 240. For example, the mounting area of the middle frame 260 may overlap the bezel area BZ of the liquid crystal panel 100. The active area AA of the liquid crystal panel 100 may not overlap the mounting area of the middle frame 260. For example, the central area of the optical sheet 240 may be exposed by the middle frame 260. The mounting area of the middle frame 260 may be in direct contact with the optical sheet 240. Accordingly, in the display apparatus according to one embodiment of the present disclosure, movement of the optical sheet 240 may be prevented by the middle frame 260.

The optical module 300 may detect external light having passed through the liquid crystal panel 100. For example, the optical module 300 may include at least one of a camera or an infrared (IR) sensor. The camera and IR sensor of the optical module 300 may overlap the sensing area HA of the liquid crystal panel 100.

The optical module 300 may be located on the bottom cover 250. For example, the bottom cover 250 may include a cover hole that overlaps the sensing area HA of the liquid crystal panel 100.

An auxiliary light source module 400 may be disposed between the optical module 300 and the backlight guide plate 220. For example, the auxiliary light source module 400 may be disposed between the optical module 300 and the reflector 230.

The auxiliary light source module 400 may include the auxiliary light source AL and the auxiliary light guide plate 420. The auxiliary light source AL may supply light to the sensing area HA and the peripheral area SA through the auxiliary light guide plate 420. For example, the auxiliary light guide plate 420 may overlap the sensing area HA and the peripheral area SA.

The backlight source PL and the auxiliary light source AL may be turned on while an image is displayed in the active area AA, and may be turned off to detect external light by the optical module 300 while the optical module 300 is driven.

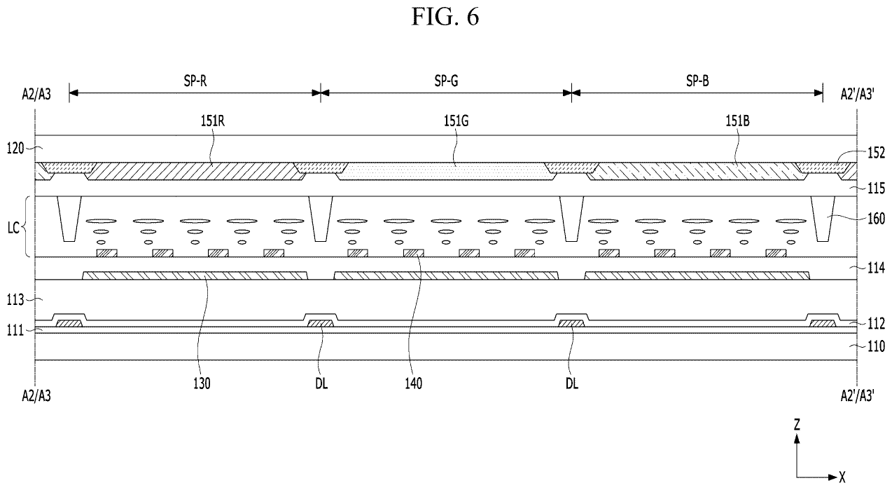

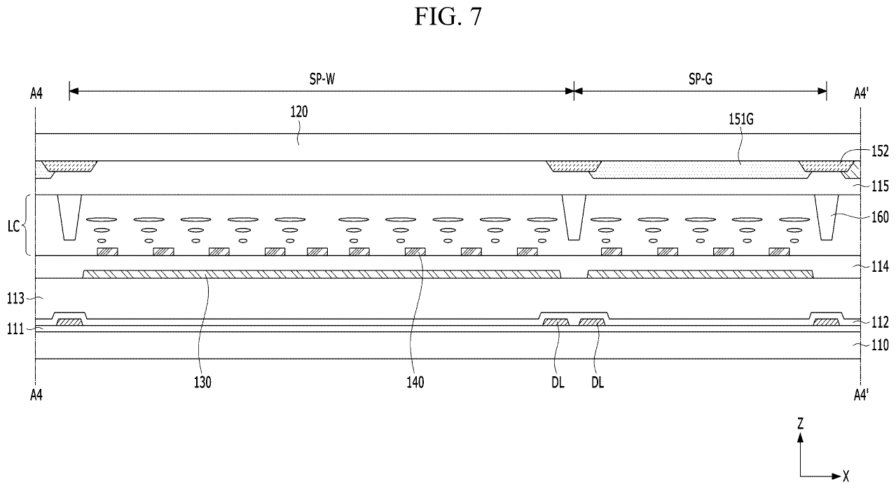

FIG. 5 is an enlarged view of area K2 of FIG. 1, FIG. 6 is a view illustrating an example of a cross-section taken along line A2-A2′ and A3-A3′ of FIG. 5, and FIG. 7 is a view illustrating an example of a cross-section taken along line A4-A4′ of FIG. 5.

In FIGS. 5 to 8(b), the plurality of subpixels may include red subpixels SP-R that display red (R), green subpixels SP-G that display green (G), blue subpixels SP-B that display blue (B), and white subpixels SP-W that display white (W).

As shown in FIG. 5, in each of the active area AA and the peripheral area SA, the plurality of subpixels may have the same width and length, and the color arrangements of the subpixels may be the same.

For example, in the active area AA and the peripheral area SA, the plurality of subpixels may be arranged such that the red subpixel SP-R, the green subpixel SP-G, and the blue subpixel SP-B are sequentially repeated in the first direction (the x-axis direction).

In the active area AA and the peripheral area SA, the structure of each of the plurality of subpixels may be the same. For example, as shown in FIG. 5, in the active area AA and the peripheral area SA, the width and length of each of the plurality of subpixels may be the same, and as shown in FIG. 6, in the active area AA and the peripheral area SA, the cross-sectional structure of each of the plurality of subpixels may be the same. Accordingly, the aperture ratios or transmittances of the active area AA and the peripheral area SA by the liquid crystal panel 100 may be the same.

In addition, in each of the active area AA and the peripheral area SA, each of the plurality of red subpixels SP-R, the plurality of green subpixels SP-G, and the plurality of blue subpixels SP-B may be arranged in a line in the second direction (the y-axis direction).

Any one of the red, green, and blue subpixels located in the sensing area HA may be arranged in a line with any one of the red, green, and blue subpixels located in the peripheral area SA in the second direction (the y-axis direction). For example, the red subpixels SP-R in the sensing area HA may be arranged in a line with the red subpixels SP-R in the peripheral area SA in the second direction (the y-axis direction), the green subpixels SP-G in the sensing area HA may be arranged in a line with the green subpixels SP-G in the peripheral area SA, or the blue subpixels SP-B in the sensing area HA may be arranged in a line with the blue subpixels SP-B in the peripheral area SA.

The number of white subpixels SP-W per unit area positioned in the sensing area HA may be greater than the number of white subpixels SP-W per unit area positioned in the active area AA and the peripheral area SA. For example, the active area AA and the peripheral area SA may not include white subpixels SP-W, and the sensing area HA may include white subpixels SP-W.

Here, one of the width and length of the white subpixels SP-W positioned in the sensing area HA may be larger than one of the width and length of the subpixels positioned in the active area AA and the peripheral area SA. FIG. 5 illustrates a case in which the width of some of the white subpixels SP-W positioned in the sensing area HA is greater than the width of the subpixels positioned in the active area AA and the peripheral area SA, as an example. Accordingly, the aperture ratio or transmittance of the sensing area HA may be higher than the aperture ratio or transmittance of the active area AA and the peripheral area SA.

The white subpixels SP-W positioned in the sensing area HA may not be provided with a color filter.

For example, as shown in FIG. 6, in the cross-section of the active area AA or the peripheral area SA, each subpixel may be provided with a color filter. Specifically, the red subpixels SP-R may have a red color filter 151R, the green subpixels SP-G may have a green color filter 151G, and the blue subpixels SP-B may have a blue color filter 151B.

However, the sensing area HA may further have the white subpixels SP-W in addition to the red subpixels SP-R, the green subpixels SP-G, and the blue subpixels SP-B, the white subpixels SP-W may not have a color filter, as in FIG. 7, and the width of at least some of the white subpixels SP-W may be greater than the width of the red, green, and blue subpixels SP-R, SP-G, and SP-B.

Accordingly, an area occupied by the black matrix per unit area in the sensing area HA may be smaller than an area occupied by the black matrix per unit area in the active area AA and the peripheral area SA. Accordingly, the aperture ratio of the sensing area HA may be greater than that of the active area AA and the peripheral area SA.

Furthermore, as shown in FIG. 7, in the sensing area HA, the red, green, and blue subpixels SP-R, SP-G, and SP-B have color filters, but the white subpixels SP-W does not have a color filter, so the transmittance of the sensing area HA in the liquid crystal panel 100 may be greater than the transmittance of the active area AA and the peripheral area SA in the liquid crystal panel 100. Accordingly, the present disclosure may further improve an external light detection capability by the optical module 300.

As described above, the active area AA is driven by the backlight source PL, the sensing area HA and the peripheral area SA are driven by the auxiliary light source AL, and if the structures of the subpixels located in the sensing area HA is different from the structure of the subpixels located in each of the active area AA and the peripheral area SA, when an image is displayed on the liquid crystal panel 100, a difference in luminosity efficiency may occur in the sensing area HA and the peripheral area SA compared to the active area AA.

The display apparatus of the present disclosure may improve the above-described difference in luminosity efficiency by supplying a data voltage of a lower level than the data voltage supplied to the active area AA to the sensing area HA or to the peripheral area SA depending on the brightness of the auxiliary light source AL. This will be described in detail below.

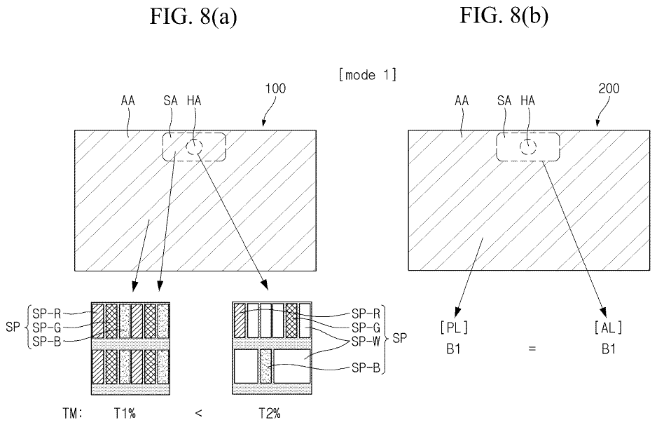

Hereinafter, a case in which the liquid crystal layer LC is driven as being normally black will be described as an example with reference to FIGS. 8(a) to 15.

FIGS. 8(a) to 11 are diagrams illustrating a method of improving the difference in luminosity efficiency in the sensing area and the peripheral area compared to the active area, when the sensing area and the peripheral area are driven in a mono mode according to a first embodiment of the present disclosure.

FIG. 8(a) shows the transmittance TM of the active area AA and the peripheral area SA and the transmittance TM of the sensing area HA in the mono mode (mode 1), and FIG. 8(b) shows the brightness of the backlight source PL that supplies light to the active area AA and the brightness of the auxiliary light source AL that supplies light to the peripheral area SA and the sensing area HA in the mono mode (mode 1).

The transmittance TM of the liquid crystal panel 100 may vary depending on the structure of the subpixels and the state of the liquid crystal layer LC. That is, as the aperture ratio of the subpixels increases and as the data voltage applied to the liquid crystal layer LC increases, the transmittance TM of the liquid crystal panel 100 may increase, and as the aperture ratio of the subpixels decreases and as the data voltage applied to the liquid crystal layer LC decreases, the transmittance TM of the liquid crystal panel 100 may decrease.

In the present disclosure, the mono mode (mode 1) may mean a state in which the liquid crystal layer LC positioned in the active area AA, the peripheral area SA, and the sensing area HA is fully on, and may be a case in which all subpixels of the active area AA and the peripheral area SA and all subpixels of the sensing area HA display full white.

When the liquid crystal panel 100 displays full white, the active area AA and the peripheral area SA may have the same structure and arrangement of the plurality of subpixels provided therein, and thus may have the same transmittance TM of T1%.

However, the sensing area HA may have a relatively high ratio of the white subpixels SP-W that do not have a color filter, unlike the active area AA and the peripheral area SA, and thus may have a transmittance TM of T2% that is higher than T1% due to the structure of the liquid crystal panel 100.

In this state, as shown in FIG. 8(b), in order to improve the difference in luminosity efficiency between images displayed in the active area AA and the peripheral area SA, the present disclosure may cause the backlight source PL driving the active area AA and the auxiliary light source AL driving the sensing area HA and the peripheral area SA to emit light with the same brightness B1.

Here, each of the brightness B1 of the backlight source PL and the brightness B1 of the auxiliary light source AL may be the brightness before light from each of the backlight source PL and the auxiliary light source AL passes through the liquid crystal panel 100. The meaning that the light from the backlight source PL and the light from the auxiliary light source AL are the same may indicate, for example, that the maximum brightness of the backlight source PL and the maximum brightness of the auxiliary light source AL are the same, or that a driving voltage applied to the backlight source PL and a driving voltage applied to the auxiliary light source AL are the same, so that the brightness of light emitted by the backlight source PL and the brightness of light emitted by the auxiliary light source AL are the same. However, the present disclosure is not necessarily limited thereto.

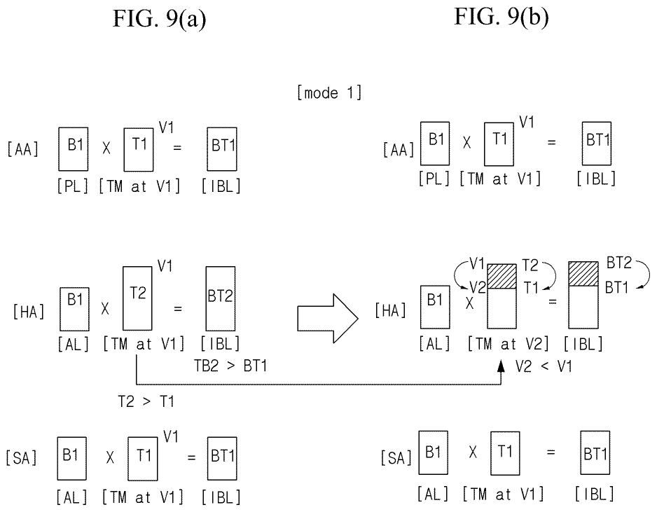

Specifically, in the case of being driven in the mono mode (mode 1), when a first voltage V1 as a data voltage is applied to the active area AA, the peripheral area SA, and the sensing area HA, as shown in FIG. 9(a), the active area AA and the peripheral area SA have the same transmittance TM of T1%, the backlight source PL and the auxiliary light source AL have the same brightness of B1, and thus, the active area AA and the peripheral area SA have the same brightness of BT1 and there may be almost no difference in luminosity efficiency.

However, since the sensing area HA has a higher transmittance TM of T2% than the active area AA and the peripheral area SA, the brightness IBL of an image displayed in the sensing area HA may be BT2, which is higher than BT1. Thereby, the brightness IBL of the image in the sensing area HA may be different compared to the active area AA and the peripheral area SA, thus causing a sense of incongruity and a difference in luminosity efficiency between images displayed in the respective areas.

In consideration of this, the present disclosure applies a second voltage V2 lower than the first voltage V1 as the data voltage to the sensing area HA, as shown in FIG. 9(b), thereby lowering the transmittance TM of the sensing area HA from T2% to T1%, and thus lowering the brightness IBL of the image displayed in the sensing area HA from BT2 to BT1. Thereby, a difference in luminosity efficiency between the sensing area HA, and the active area AA and the peripheral area SA may be reduced, and thus the quality of an image displayed on the liquid crystal panel 100 may be improved.

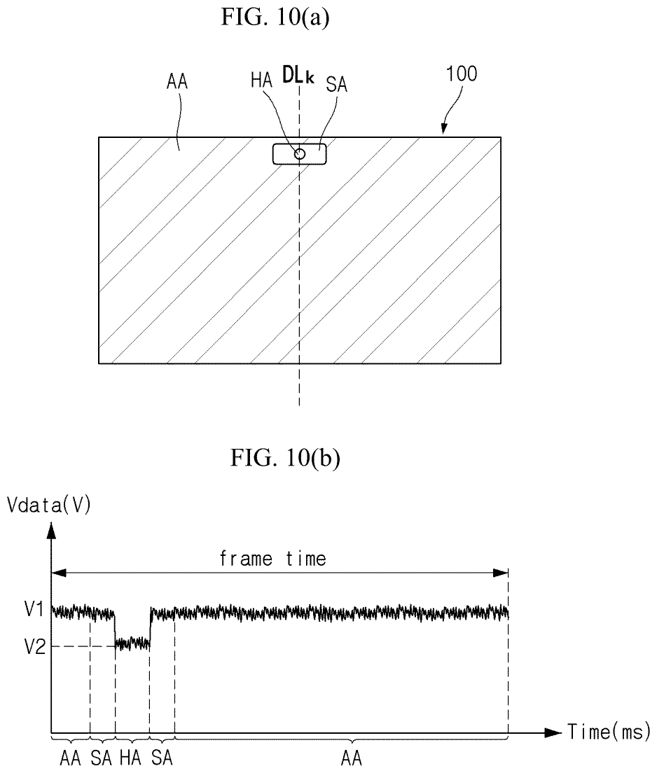

Therefore, as shown in FIG. 10(a), in a data line DLₖ passing through the active area AA, the peripheral area SA, and the sensing area HA, a data voltage, which is different from a data voltage supplied to the active area AA and the peripheral area SA, may be supplied to the sensing area HA.

For example, as shown in FIG. 10(b), during one frame time, when scan signals are supplied to the subpixels located in each of the active area AA and the peripheral area SA, the first voltage V1 is supplied, but when scan signals are supplied to the subpixels in the sensing area HA, the second voltage V2 lower than the first voltage V1 may be supplied.

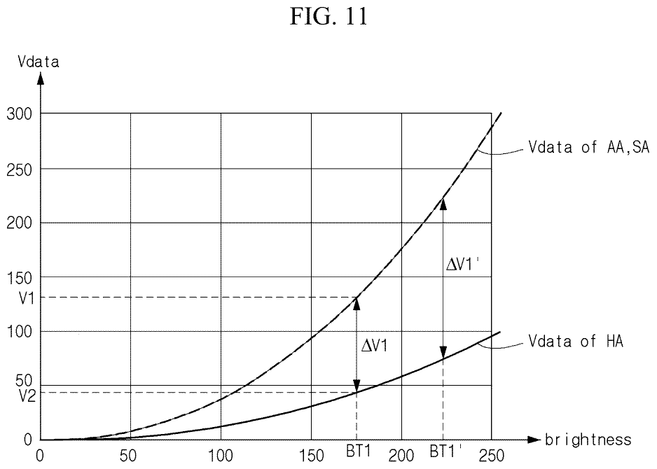

In addition, as shown in FIG. 11, a difference ΔV1 between the data voltage (Vdata of AA, SA) supplied to the active area AA and the peripheral area SA and the data voltage (Vdata of HA) supplied to the sensing area HA may increase as the brightness of the backlight source PL and the auxiliary light source AL increases.

That is, as the brightness of the backlight source PL and the auxiliary light source AL increases, a difference between the brightness IBL of an image displayed in the sensing area HA and the brightness IBL of an image displayed in the active area AA and the peripheral area SA may increase.

Considering this point, the present disclosure may further increase the difference between the data voltage of the sensing area HA and the data voltage of the active area AA and the peripheral area SA from ΔV1 to ΔV1′, as the brightness of the backlight source PL and the auxiliary light source AL increases.

A case in which the liquid crystal layer LC is driven as being normally black has been described as an example in FIG. 8(a) to 11, but in the case in which the liquid crystal layer LC is driven as being normally white, contrary to the description given with reference to FIGS. 8(a) to 11, the data voltage (Vdata of HA) of the sensing area HA may be greater than the data voltage (Vdata of AA, SA) of the active area AA and the peripheral area SA in the mono mode (mode 1).

Up to now, in order to improve the difference in luminosity efficiency in the sensing area HA and the peripheral area SA compared to the active area AA, the case in which a different data voltage is supplied to the sensing area HA while the brightness of the backlight source PL and the brightness of the auxiliary light source AL are set to the same value has been described as an example, but the present disclosure is not limited thereto.

For example, in some cases, the sensing area HA may display pure colors. That is, all the white subpixels SP-W located in the sensing area HA may be turned off, and only the red, green, and blue subpixels SP-R, SP-G, and SP-B may be turned on. In this case, since all the white subpixels SP-W are turned off, the transmittance TM of the sensing area HA may be lower than that of the peripheral area SA and the active area AA, and the resolution of the sensing area HA may be changed.

In this case, the present disclosure may make the brightness of the auxiliary light source AL greater than that of the backlight source PL in order to compensate for the low transmittance TM of the sensing area HA. At this time, the brightness IBL of an image displayed in the peripheral area SA may be different from the brightness IBL of an image displayed in the active area AA and the sensing area HA, and thus, a sense of incongruity in the images may occur.

Considering this point, the present disclosure may make a data voltage supplied to the peripheral area SA different from a data voltage supplied to the active area AA and the sensing area HA. Hereinafter, a method of improving a difference in luminosity efficiency occurring between the image of the peripheral area SA and the image of the active area AA and the sensing area HA will be described.

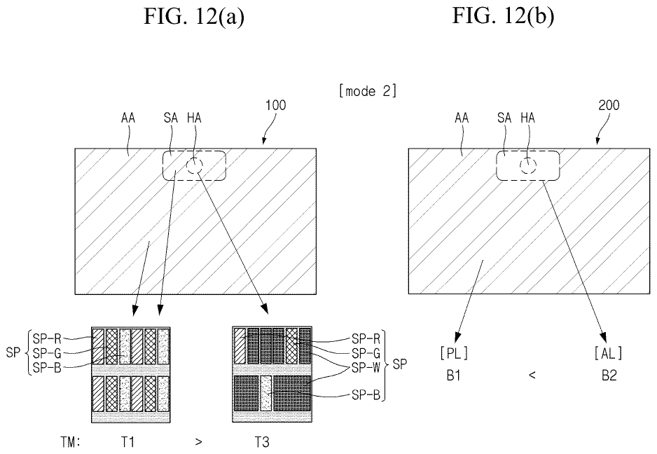

FIGS. 12(a) to 15 are diagrams illustrating a method of improving a difference in luminosity efficiency in the sensing area and the peripheral area compared to the active area, when the sensing area and the peripheral area are driven in a resolution change mode according to a second embodiment of the present disclosure.

As shown in FIGS. 12(a) and 12(b), in some cases, the liquid crystal panel 100 may be driven in a resolution change mode (mode 2) in which the white subpixels SP-W are turned off.

In the case of being driven in the resolution change mode (mode 2), as shown in FIG. 12(a), the red, green, and blue subpixels SP-R, SP-G, and SP-B may be turned on in the active area AA and the peripheral area SA, and the white subpixels SP-W may be turned off and the red, green, and blue subpixels SP-R, SP-G, and SP-B may be turned on in the sensing area HA.

In this case, the active area AA and the peripheral area SA may have the same transmittance TM of T1% because the structures and color arrangements of the subpixels in the active area AA and the peripheral area SA are the same. However, the sensing area HA may have a lower resolution than the active area AA and the peripheral area SA, and may have a transmittance TM of T3% that is lower than T1% due to the white subpixels SP-W being turned off.

In consideration of the relatively low transmittance TM of the sensing area HA, the present disclosure may improve a difference in luminosity efficiency between the sensing area HA and the active area AA by making the second brightness B2 of the auxiliary light source AL higher than the first brightness B1 of the backlight source PL.

However, in this case, due to the high second brightness B2 of the auxiliary light source AL, the brightness BT3 of an image displayed in the peripheral area SA may be different from the brightness BT1 of an image displayed in the active area AA or the sensing area HA, thereby being causing a difference in luminosity efficiency.

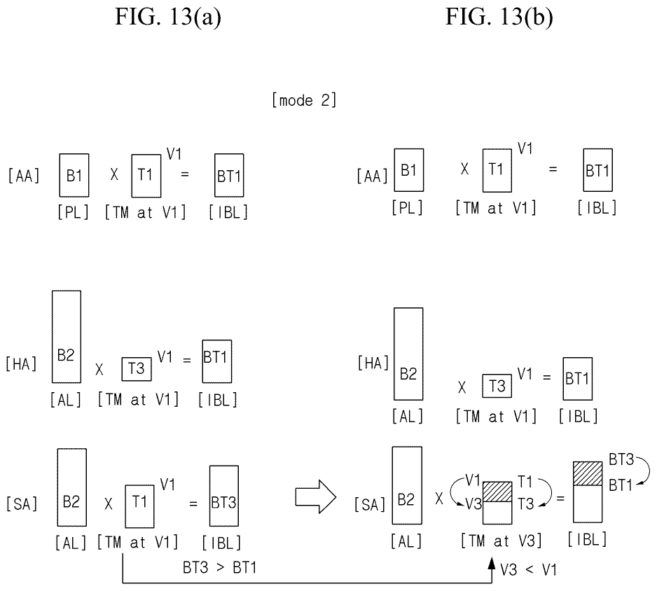

More specifically, as shown in FIG. 13(a), in the resolution change mode (mode 2), when the same first voltage V1 as a data voltage is supplied to the active area AA, the peripheral area SA, and the sensing area HA, the transmittance T3 of the sensing area HA may become smaller than the transmittance T1 of the active area AA due to the white subpixels SP-W being turned off.

The present disclosure, considering the difference in transmittance between the active area AA and the sensing area HA, may make the second brightness B2 of the auxiliary light source AL higher than the first brightness B1 of the backlight source PL, thereby being capable of making the brightness BT1 of the image displayed in the active area AA and the brightness BT1 of the image displayed in the sensing area HA the same, and thus improving the difference in luminosity efficiency between the active area AA and the sensing area HA.

However, in this case, since light from the auxiliary light source AL having the second brightness B2 is supplied while the peripheral area SA has the same transmittance T1 as the active area AA, the brightness BT3 of an image displayed in the peripheral area SA may be higher than the brightness BT1, and the peripheral area SA may have a difference in luminosity efficiency with the active area AA and the sensing area HA.

The present disclosure may, considering the difference in luminosity efficiency of the peripheral area SA, lower the data voltage supplied to the peripheral area SA from the first voltage V1 to a third voltage V3, thereby being capable of lowering the transmittance TM of the peripheral area SA from T1 to T3. Accordingly, the brightness IBL of the image displayed in the peripheral area SA may be lowered from BT3 to BT1, thereby being capable of overcoming the difference in luminosity efficiency of the peripheral area SA.

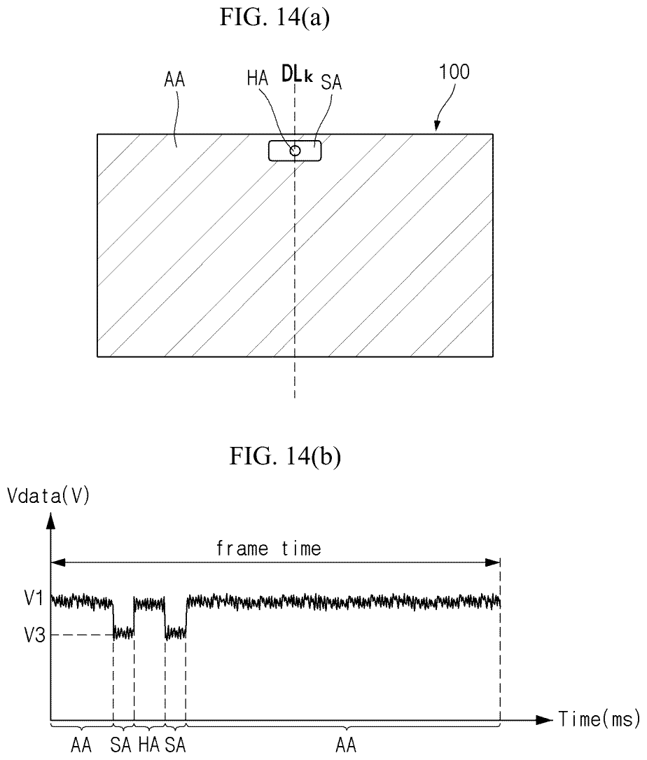

As shown in FIG. 14(a), in the data line DLₖ passing through the active area AA, the peripheral area SA, and the sensing area HA, a data voltage, which is different from a data voltage supplied to the active area AA and the sensing area HA, may be supplied to the peripheral area SA.

For example, as shown in FIG. 14(b), during one frame time, the first voltage V1 may be supplied to the active area AA and the sensing area HA, but the third voltage V3 lower than the first voltage V1 may be supplied to the peripheral area SA.

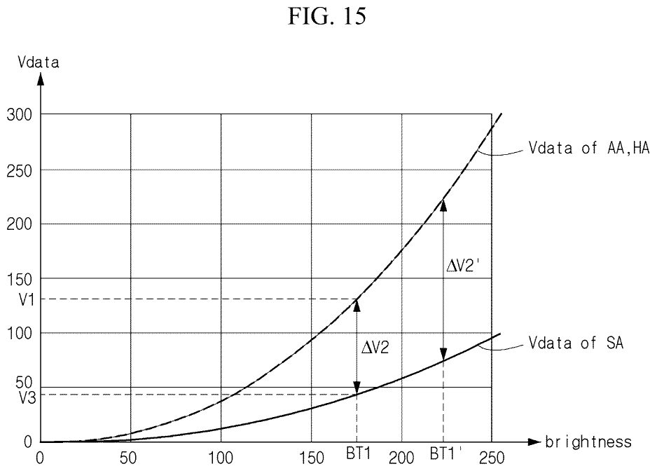

In addition, as shown in FIG. 15, a difference ΔV1 between the data voltage (Vdata of AA, HA) supplied to the active area AA and the sensing area HA and the data voltage (Vdata of SA) supplied to the peripheral area SA may increase from ΔV2 to ΔV2′ as the brightness IBL of an image displayed by the liquid crystal panel 100 increases from BT1 to BT1′.

A case in which the liquid crystal layer LC is driven as being normally black has been described as an example in FIGS. 12(a) to 15, but in the case in which the liquid crystal layer LC is driven as being normally white, contrary to the description given with reference to FIGS. 12(a) to 15, the data voltage (Vdata of SA) of the peripheral area SA may be greater than the data voltage (Vdata of AA, HA) of the active area AA and the sensing area AA in the resolution change mode (mode 2).

In this way, the display apparatus according to one embodiment of the present disclosure may supply a data voltage of a different level from a data voltage supplied to the active area AA to the sensing area HA or the peripheral area SA depending on the brightness of the auxiliary light source AL, thereby being capable of minimizing a sense of incongruity that may occur between an image of the active area AA and an image of the sensing area HA or the peripheral area SA.

As is apparent from the above description, a display apparatus according to one embodiment of the present disclosure may supply a data voltage of a different level from a data voltage supplied to an active area to a sensing area or a peripheral area depending on the brightness of an auxiliary light source, thereby being capable of minimizing a sense of incongruity that may occur between an image of the active area and an image of the sensing area or the peripheral area.

Through the above description, it should be apparent to those skilled in the art that various changes and modifications are possible without departing from the technical spirit of the present disclosure. Therefore, the technical scope of the present disclosure should not be limited to the above detailed description of the specification, but should be defined by the scope of the claims. Also disclosed herein are a number of examples according to the following numbered clauses:
Clause 1. A display apparatus comprising: a liquid crystal panel (e.g., 100) comprising an active area (e.g., AA), a sensing area (e.g., HA) surrounded by the active area (e.g., AA), and a peripheral area (e.g., SA) located between the active area (e.g., AA) and the sensing area (e.g., HA); a backlight unit (e.g., 200) having a backlight source (e.g., PL) configured to supply light to the active area (e.g., AA) through a backlight guide plate (e.g., 220); an auxiliary light source module (e.g., 400) having an auxiliary light source (e.g., AL) that supplies light to the sensing area (e.g., HA) and the peripheral area (e.g., SA) through an auxiliary light guide plate (e.g., 420); and an optical module (e.g., 300) located on a rear surface of the backlight unit (e.g., 200) and the auxiliary light source module (e.g., 400), and configured to detect external light through the sensing area (e.g., HA), wherein: a data voltage is supplied to at least one subpixel located in each of the active area (e.g., AA), the sensing area (e.g., HA), and the peripheral area (e.g., SA) to display an image on the liquid crystal panel (e.g., 100); and the data voltage supplied to one of: the sensing area (e.g., HA) and the peripheral area (e.g., SA) is different from the data voltage supplied to the active area (e.g., AA) to improve luminosity efficiency of the image displayed on the liquid crystal panel (e.g., 100).
Clause 2. The display apparatus in clause 1, wherein the liquid crystal panel (e.g., 100) includes a plurality of red subpixels (e.g., SP-R), a plurality of green subpixels (e.g., SP-G), and a plurality of blue subpixels (e.g., SP-B) in the active area (e.g., AA), the peripheral area (e.g., SA) and the sensing area (e.g., HA), and additionally, a plurality of white subpixels (e.g., SP-W) in the sensing area (e.g., HA) for high transmittance of the sensing area (e.g., HA) for the external light detection.
Clause 3. The display apparatus in clause 1, wherein a subpixel structure and color arrangement in the peripheral area (e.g., SA) are the same as a subpixel structure and color arrangement in the active area (e.g., AA).
Clause 4. The display apparatus in clause 1, wherein one of: width and length of at least one white subpixel (e.g., SP-W) positioned in the sensing area (e.g., HA) is larger than one of: width and length of the subpixels positioned in the active area (e.g., AA) and the peripheral area (e.g., SA).
Clause 5. The display apparatus in clause 1, wherein a number of white subpixels (e.g., SP-W) per unit area positioned in the sensing area (e.g., HA) is greater than a number of white subpixels (e.g., SP-W) per unit area positioned in each of the active area (e.g., AA) and the peripheral area (e.g., SA).
Clause 6. The display apparatus in clause 2, wherein the red subpixels (e.g., SP-R) have a red color filter (e.g., 151R), the green subpixels (e.g., SP-G) have a green color filter (e.g., 151G), and the blue subpixels (e.g., SP-B) have a blue color filter (e.g., 151B).
Clause 7. The display apparatus in clause 1, wherein the liquid crystal panel (e.g., 100) is driven in a mono mode, wherein the plurality of red subpixels (e.g., SP-R), the plurality of green subpixels (e.g., SP-G), the plurality of blue subpixels (e.g., SP-B) in the active area (e.g., AA), the peripheral area (e.g., SA) and the sensing area (e.g., HA), and additionally, the plurality of white subpixels (e.g., SP-W) in the sensing area (e.g., HA) are turned on.
Clause 8. The display apparatus in clause 7, wherein a brightness of the auxiliary light source (e.g., AL) is the same as a brightness of the backlight source (e.g., PL).
Clause 9. The display apparatus in clause 7, wherein the data voltage supplied to the sensing area (e.g., HA) is lower than the data voltage supplied to the active area (e.g., AA) and the peripheral area (e.g., SA).
Clause 10. The display apparatus in clause 7, wherein a difference between the data voltage supplied to the active area (e.g., AA) and the peripheral area (e.g., SA), and the data voltage supplied to the sensing area (e.g., HA) increases as the brightness of the backlight source (e.g., PL) and the auxiliary light source (e.g., AL) increases.
Clause 11. The display apparatus in clause 1, wherein the liquid crystal panel (e.g., 100) is driven in a resolution change mode wherein the plurality of red subpixels (e.g., SP-R), the plurality of green subpixels (e.g., SP-G), and the plurality of blue subpixels (e.g., SP-B) in the active area (e.g., AA), the peripheral area (e.g., SA) and the sensing area (e.g., HA) are turned on, and the plurality of white subpixels (e.g., SP-W) in the sensing area are turned off.
Clause 12. The display apparatus in clause 11, wherein a brightness of the auxiliary light source (e.g., AL) is greater than a brightness of the backlight source (e.g., PL).
Clause 13. The display apparatus in clause 11, wherein the data voltage supplied to the peripheral area (e.g., SA) is lower than the data voltage supplied to the active area (e.g., AA) and the sensing area (e.g., HA).
Clause 14. The display apparatus in clause 11, wherein a difference between the data voltage supplied to the active area (e.g., AA) and the sensing area (e.g., HA), and the data voltage supplied to the peripheral area (e.g., SA) increases as the brightness of an image displayed by the liquid crystal panel (e.g., 100) increases.
Clause 15. The display apparatus in clause 1, wherein the backlight source (e.g., PL) and the auxiliary light source (e.g., AL) are turned on while an image is displayed on the liquid crystal panel (e.g., 100), and are turned off for the external light detection by the optical module (e.g., 300).
Clause 16. The display apparatus in clause 1, wherein the backlight unit (e.g., 200) includes at least one optical sheet (e.g., 240) between the liquid crystal panel (e.g., 100) and the backlight guide plate (e.g., 220), and the at least one optical sheet (e.g., 240) has an optical sheet hole (e.g., 240h) in a portion thereof configured to overlap the sensing area (e.g., HA) for high transmittance of the sensing area (e.g., HA).
Clause 17. The display apparatus in clause 1, wherein the optical module (e.g., 300) includes at least one of: a camera and an IR sensor in a portion thereof configured to overlap the sensing area (e.g., HA).
Clause 18. A display apparatus comprising: a liquid crystal panel (e.g., 100) comprising an active area (e.g., AA), a sensing area (e.g., HA) located to be surrounded by the active area (e.g., AA), and a peripheral area (e.g., SA) located between the active area (e.g., AA) and the sensing area (e.g., HA); a backlight unit (e.g., 200) having a backlight source (e.g., PL) configured to supply light to the active area (e.g., AA) through a backlight guide plate (e.g., 220); an auxiliary light source module (e.g., 400) having an auxiliary light source (e.g., AL) that supplies light to the sensing area (e.g., HA) and the peripheral area (e.g., SA) through an auxiliary light guide plate (e.g., 420); and an optical module (e.g., 300) located on a rear surface of the backlight unit (e.g., 200) and the auxiliary light source module (e.g., 400), and configured to detect external light through the sensing area (e.g., HA), wherein: a data voltage is supplied to at least one subpixel located in each of the active area (e.g., AA), the sensing area (e.g., HA), and the peripheral area (e.g., SA) to display an image on the liquid crystal panel (e.g., 100); and the data voltage supplied to one of: the sensing area (e.g., HA) and the peripheral area (e.g., SA) is varied from the data voltage supplied to the active area (e.g., AA) based on a mode in which the liquid crystal panel (e.g., 100) is driven, to improve luminosity efficiency of the image displayed on the liquid crystal panel (e.g., 100).
Clause 19. The display apparatus in clause 18, wherein the liquid crystal panel (e.g., 100) includes a plurality of red subpixels (e.g., SP-R), a plurality of green subpixels (e.g., SP-G), and a plurality of blue subpixels (e.g., SP-B)in the active area (e.g., AA), the peripheral area (e.g., SA) and the sensing area (e.g., HA), and additionally, a plurality of white subpixels (e.g., SP-W) in the sensing area (e.g., HA) for high transmittance of the sensing area (e.g., HA) for external light detection.
Clause 20. The display apparatus in clause 18, wherein a subpixel structure and color arrangement in the peripheral area (e.g., SA) are the same as a subpixel structure and color arrangement in the active area (e.g., AA).
Clause 21. The display apparatus in clause 18, wherein one of: width and length of at least one white subpixel (e.g., SP-W) positioned in the sensing area (e.g., HA) is larger than one of: width and length of the subpixels positioned in the active area (e.g., AA) and the peripheral area (e.g., SA).
Clause 22. The display apparatus in clause 18, wherein the liquid crystal panel (e.g., 100) is driven in one of: a mono mode and a resolution change mode.
Clause 23. The display apparatus in clause 22, wherein the plurality of red subpixels (e.g., SP-R), the plurality of green subpixels (e.g., SP-G), and the plurality of blue subpixels (e.g., SP-B) in the active area (e.g., AA), the peripheral area (e.g., SA) and the sensing area (e.g., HA), and additionally, the plurality of white subpixels (e.g., SP-W) in the sensing area (e.g., HA) are turned on in the mono mode.
Clause 24. The display apparatus in clause 23, wherein a brightness of the auxiliary light source (e.g., AL) is the same as a brightness of the backlight source (e.g., PL).
Clause 25. The display apparatus in clause 23, wherein the data voltage supplied to the sensing area (e.g., HA) is lower than the data voltage supplied to the active area (e.g., AA) and the peripheral area (e.g., SA).
Clause 26. The display apparatus in clause 23, wherein a difference between the data voltage supplied to the active area (e.g., AA) and the peripheral area (e.g., SA), and the data voltage supplied to the sensing area (e.g., HA) increases as the brightness of the backlight source (e.g., PL) and the auxiliary light source (e.g., AL) increases.
Clause 27. The display apparatus in clause 22, wherein the plurality of red subpixels (e.g., SP-R), the plurality of green subpixels (e.g., SP-G), and the plurality of blue subpixels (e.g., SP-B) in the active area (e.g., AA), the peripheral area (e.g., SA) and the sensing area (e.g., HA) are turned on, and the plurality of white subpixels (e.g., SP-W) in the sensing area (e.g., HA) are turned off in the resolution change mode.
Clause 28. The display apparatus in clause 27, wherein a brightness of the auxiliary light source (e.g., AL) is greater than a brightness of the backlight source (e.g., PL).
Clause 29. The display apparatus in clause 27, wherein the data voltage supplied to the peripheral area (e.g., SA) is lower than the data voltage supplied to the active area (e.g., AA) and the sensing area (e.g., HA).
Clause 30. The display apparatus in clause 27, wherein a difference between the data voltage supplied to the active area (e.g., AA) and the sensing area (e.g., HA), and the data voltage supplied to the peripheral area (e.g., SA) increases as the brightness of an image displayed by the liquid crystal panel (e.g., 100) increases.
Clause 31. The display apparatus in clause 18, wherein the backlight unit (e.g., 200) includes at least one optical sheet (e.g., 240) between the liquid crystal panel (e.g., 100) and the backlight guide plate (e.g., 220), and the at least one optical sheet (e.g., 240) has an optical sheet hole (e.g., 240h) in a portion thereof configured to overlap the sensing area (e.g., HA) for high transmittance of the sensing area (e.g., HA).
Clause 32. The display apparatus in clause 18, wherein the optical module (e.g., 300) includes at least one of: a camera and an IR sensor in a portion thereof configured to overlap the sensing area (e.g., HA).

What is claimed is:

1. A display apparatus, comprising:
a liquid crystal panel comprising an active area, a sensing area surrounded by the active area, and a peripheral area located between the active area and the sensing area;
a backlight unit having a backlight source configured to supply light to the active area through a backlight guide plate;
an auxiliary light source configured to supply light to the sensing area and the peripheral area; and
an optical module located on a rear surface of the backlight unit and configured to detect external light through the sensing area,
wherein:
the display apparatus is configured to supply a data voltage to at least one subpixel located in each of the active area, the sensing area, and the peripheral area; and
the data voltage supplied to the sensing area or the peripheral area is different from the data voltage supplied to the active area.

2. The display apparatus according to claim 1, wherein a number of white subpixels configured to display white per unit area positioned in the sensing area is greater than a number of white subpixels per unit area positioned in each of the active area and the peripheral area.

3. The display apparatus according to claim 1, wherein:
subpixels configured to display red, green, or blue and subpixels configured to display white are located in the sensing area; and
subpixels configured to display red, green, or blue are located in the active area and the peripheral area, and subpixels configured to display white are not located in the active area and the peripheral area.

4. The display apparatus according to claim 1, wherein:
a brightness of the auxiliary light source is same as a brightness of the backlight source;
a first voltage is supplied as the data voltage to the at least one subpixel located in each of the active area and the peripheral area; and
a second voltage different from the first voltage is supplied as the data voltage to the at least one subpixel located in the sensing area.

5. The display apparatus according to claim 4, wherein the second voltage is lower than the first voltage.

6. The display apparatus according to claim 4, wherein a difference between the first voltage and the second voltage increases as the brightness of the backlight source and the auxiliary light source increases.

7. The display apparatus according to claim 1, wherein
a brightness of the auxiliary light source is higher than a brightness of the backlight source;
a first voltage is supplied as the data voltage to at least one subpixel turned on among a plurality of subpixels located in the sensing area and the at least one subpixel located in the active area; and
a third voltage different from the first voltage is supplied as the data voltage to the at least one subpixel located in the peripheral area.

8. The display apparatus according to claim 7, wherein the third voltage is lower than the first voltage.

9. The display apparatus according to claim 7, wherein among the plurality of subpixels located in the sensing area, subpixels configured to display red, green, or blue are turned on, and subpixels configured to display white are turned off.

10. The display apparatus according to claim 7, wherein a difference between the first voltage and the third voltage increases as a brightness of an image displayed on the liquid crystal panel increases.

11. The display apparatus according to claim 2, wherein the white subpixels are not provided with a color filter having red, green, or blue.

12. The display apparatus according to claim 1, further comprising an auxiliary light guide plate configured to overlap the sensing area and the peripheral area,
wherein the auxiliary light source supplies the light to the sensing area and the peripheral area through the auxiliary light guide plate.

13. The display apparatus according to claim 1, further comprising at least one optical sheet between the liquid crystal panel and the backlight guide plate,
wherein the at least one optical sheet has an optical sheet hole in a portion thereof configured to overlap the sensing area.

14. The display apparatus according to claim 1, wherein the optical module comprises at least one of a camera or an infrared (IR) sensor in a portion thereof configured to overlap the sensing area.
